(19) United States
(12) Patent Application Publication
(10) Pub. No.: US 2015/0018171 A1
(43) Pub. Date: Jan. 15, 2015

(54) CONTROL DEVICE AND CONTROL METHOD FOR SOLENOID VALVE

(71) Applicant: AISIN AW CO., LTD., Anjo-shi, Aichi-ken (JP)

(72) Inventors: Hideya Kawai, Anjo-shi (JP); Hirotaka Kataoka, Anjo-shi (JP)

(73) Assignee: AISIN AW CO., LTD., Anjo-shi, Aichi-ken (JP)

(21) Appl. No.: 14/378,528

(22) PCT Filed: Mar. 5, 2013
(86) PCT No.: PCT/JP2013/055998

§ 371 Date: Aug. 13, 2014

(30) Foreign Application Priority Data
Mar. 26, 2012 (JP) 2012-068806

(51) Int. Cl. F16K 31/06; B60W 10/02; F15B 13/02

(52) U.S. Cl. CPC F16K 31/0675; F15B 13/021; B60W 10/02
USPC 477/86; 137/624.11; 361/170

(57) ABSTRACT

A control device for a solenoid valve that controls a solenoid valve included in a hydraulic control device using a control signal set through feedback control such that an actual current that flows through a solenoid of the solenoid valve matches a command current, including a command current setting device for setting the command current within a range of an upper-limit current. The command current setting device is operable for changing the upper-limit current from a first upper-limit value to a second upper-limit value that is smaller than the first upper-limit value in accordance with a reduction in voltage of a battery that supplies electric power to the solenoid.

### TECHNICAL FIELD

The present invention relates to a control device and a control method for a solenoid valve, and in particular to a control device and a control method for a solenoid valve for controlling a solenoid valve included in a hydraulic control device using a control signal set through feedback control such that an actual current that flows through a solenoid of the solenoid valve matches a command current.

### BACKGROUND ART

Hitherto, there has been proposed as a solenoid valve control device of this type, a control device for a solenoid valve that controls a plurality of solenoid valves that supply a working hydraulic pressure to a friction engagement element of an automatic transmission for a vehicle, in which a target current for the solenoid corresponding to a target hydraulic pressure is set, a duty signal is set by performing feedback control such that an actual current detected as a current that actually flows through the solenoid matches the target current, and the duty signal is output to the solenoid to control the solenoid valve (see Patent Document 1, for example). In the device, the degree of fault of the solenoid is set on the basis of a steady control deviation between the target current and the actual current in an integral term of a relational formula for the feedback control. When the degree of fault exceeds a threshold, it is determined that a fault such as sticking is caused in the solenoid valve, which causes transition to a fail-safe mode or provides warning with a lamp.

### RELATED-ART DOCUMENTS

### Patent Documents

[Patent Document 1] Japanese Patent Application Publication No. 11-119826 (JP 11-119826 A)

### SUMMARY OF THE INVENTION

In the control device discussed above, however, when the deviation between the target current and the actual current tends to be large, the integral term of the relational formula for the feedback control may become excessively large, for example. Thus, a control failure in which the feedback control is not performed adequately may be caused, or a fault of the solenoid may be detected erroneously, and a hydraulic pressure output from the solenoid valve may not be controlled adequately.

A main object of the control device and the control method for a solenoid valve according to the present invention is to perform current control for a solenoid more adequately.

In order to achieve the foregoing main object, the control device and the control method for a solenoid valve according to the present invention adopt the following means.

The present invention provides

a control device for a solenoid valve that controls a solenoid valve included in a hydraulic control device using a control signal set through feedback control such that an actual current that flows through a solenoid of the solenoid valve matches a command current, characterized by including:

command current setting means for setting the command current within a range of an upper-limit current, in which

the command current setting means is means for changing the upper-limit current from a first upper-limit value to a second upper-limit value that is smaller than the first upper-limit value in accordance with a reduction in voltage of a battery that supplies electric power to the solenoid.

In the control device for a solenoid valve according to the present invention, the command current is set within the range of the upper-limit current, and the upper-limit current is changed from a first upper-limit value to a second upper-limit value that is smaller than the first upper-limit value in accordance with a reduction in voltage of a battery that supplies electric power to the solenoid. That is, the command current is set within the range of the first upper-limit value when the voltage of the battery is not reduced, and the command current is set within the range of the second upper-limit value which is smaller than the first upper-limit value when the voltage of the battery is reduced. When the voltage of the battery is reduced, the actual current which flows through the solenoid tends to be small, and therefore the deviation between the command current and the actual current tends to be large. Thus, the integral term of the relational formula for the feedback control may be excessively large, for example, which may not allow current control for the solenoid to be performed adequately. In order to address such an issue, the command current is restricted within the range of the smaller upper-limit value in accordance with a reduction in voltage of the battery, which prevents the deviation between the command current and the actual current for the solenoid from becoming excessively large. As a result, current control for the solenoid can be performed more adequately.

In the thus configured control device for a solenoid valve according to the present invention, the hydraulic control device may include a plurality of such solenoid valves; and the command current setting means may be means for changing the upper-limit current for at least one of the plurality of solenoid valves from the first upper-limit value to the second upper-limit value in accordance with a reduction in voltage of the battery. This allows current control for the solenoid to be performed more adequately by selecting the target for which the upper-limit current is to be changed in accordance with the type and the usage of the solenoid valve.

In the control device for a solenoid valve according to the present invention, the command current setting means may be means for changing the upper-limit current from the first upper-limit value to the second upper-limit value when the voltage of the battery is less than a threshold determined in advance as a lower limit of a voltage range allowed for normal use.

In the control device for a solenoid valve according to the present invention, in addition, the second upper-limit value may be a value set to have a tendency to become smaller as a temperature of hydraulic oil in the hydraulic control device becomes higher. This allows current control for the solenoid to be performed more adequately even in the case where the temperature of hydraulic oil becomes higher to increase the resistance value of the solenoid and hence reduce the actual current which flows through the solenoid.

In the control device for a solenoid valve according to the present invention, further, the hydraulic control device may be a device that controls a hydraulic pressure for an engagement element included in an automatic transmission mounted on a vehicle, and may include a regulator valve that generates a line pressure that serves as a source pressure for engaging the engagement element in accordance with a hydraulic pressure from the solenoid valve which outputs a hydraulic pressure matching a throttle operation amount or torque input to the automatic transmission; and the solenoid valve may be controlled such that the line pressure is brought to a maximum pressure determined in advance at least in the case where an abnormality in the solenoid valve is detected. Thus, even if erroneous detection of an abnormality in the solenoid valve is likely to be caused when the deviation between the command current and the actual current is large because of a reduction in voltage of the battery, erroneous detection of an abnormality in the solenoid valve is made unlikely by changing the upper-limit current from the first upper-limit value to the second upper-limit value in accordance with a reduction in voltage of the battery. Thus, degradation in efficiency due to the line pressure being brought to the maximum pressure can be suppressed.

The present invention also provides

a control method for a solenoid valve in which a solenoid valve included in a hydraulic control device is controlled using a control signal set through feedback control such that an actual current that flows through a solenoid of the solenoid valve matches a command current, characterized by including the step of:

setting the command current within a range of an upper-limit current, in which

the upper-limit current is changed from a first upper-limit value to a second upper-limit value that is smaller than the first upper-limit value in accordance with a reduction in voltage of a battery that supplies electric power to the solenoid.

In the control method for a solenoid valve according to the present invention, the command current is set within the range of the upper-limit current, and the upper-limit current is changed from a first upper-limit value to a second upper-limit value that is smaller than the first upper-limit value in accordance with a reduction in voltage of a battery that supplies electric power to the solenoid. That is, the command current is set within the range of the first upper-limit value when the voltage of the battery is not reduced, and the command current is set within the range of the second upper-limit value which is smaller than the first upper-limit value when the voltage of the battery is reduced. When the voltage of the battery is reduced, the actual current which flows through the solenoid tends to be small, and therefore the deviation between the command current and the actual current tends to be large. Thus, the integral term of the relational formula for the feedback control may be excessively large, for example, which may not allow current control for the solenoid to be performed adequately. In order to address such an issue, the command current is restricted within the range of the smaller upper-limit value in accordance with a reduction in voltage of the battery, which prevents the deviation between the command current and the actual current for the solenoid from becoming excessively large. As a result, current control for the solenoid can be performed more adequately.

### BRIEF DESCRIPTION OF THE DRAWINGS

FIG. 1 is a diagram illustrating a schematic configuration of a power transfer device 20 for a vehicle including an automatic transmission 25 etc.

FIG. 2 is an operation table illustrating the relationship between each shift speed of the automatic transmission 25 and the respective operating states of clutches and brakes.

FIG. 3 is a system diagram illustrating a hydraulic control device 50 controlled by a speed change electronic control unit 21 that serves as a control device according to an embodiment of the present invention.

FIG. 4 is a diagram illustrating a schematic configuration of a drive circuit 85 for a linear solenoid valve SLT.

FIG. 5 is a flowchart illustrating an example of a solenoid valve control routine executed by the speed change ECU 21.

FIG. 6 illustrates an example of how the battery mode is switched by an engine ECU 14 in accordance with the state of a battery 70.

FIG. 7 illustrates an example of an upper-limit current setting table.

FIG. 8 illustrates an example of an upper-limit current setting map according to a modification.

### MODES FOR CARRYING OUT THE INVENTION

Now, an embodiment of the present invention will be described below.

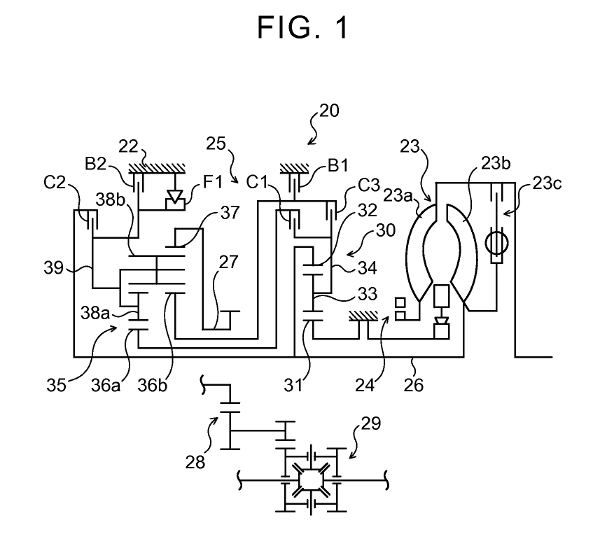

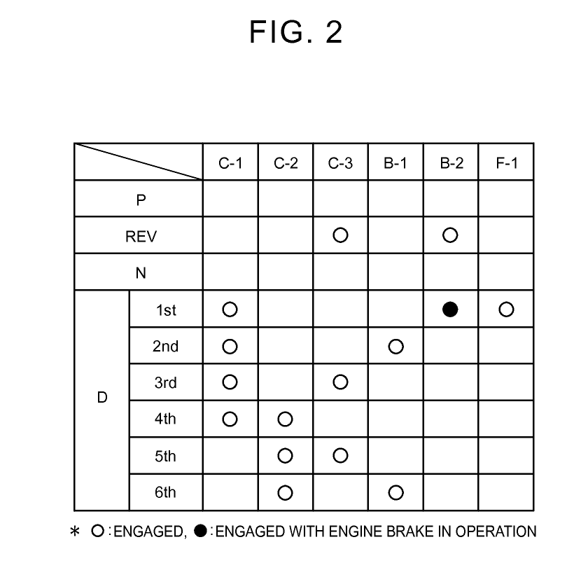

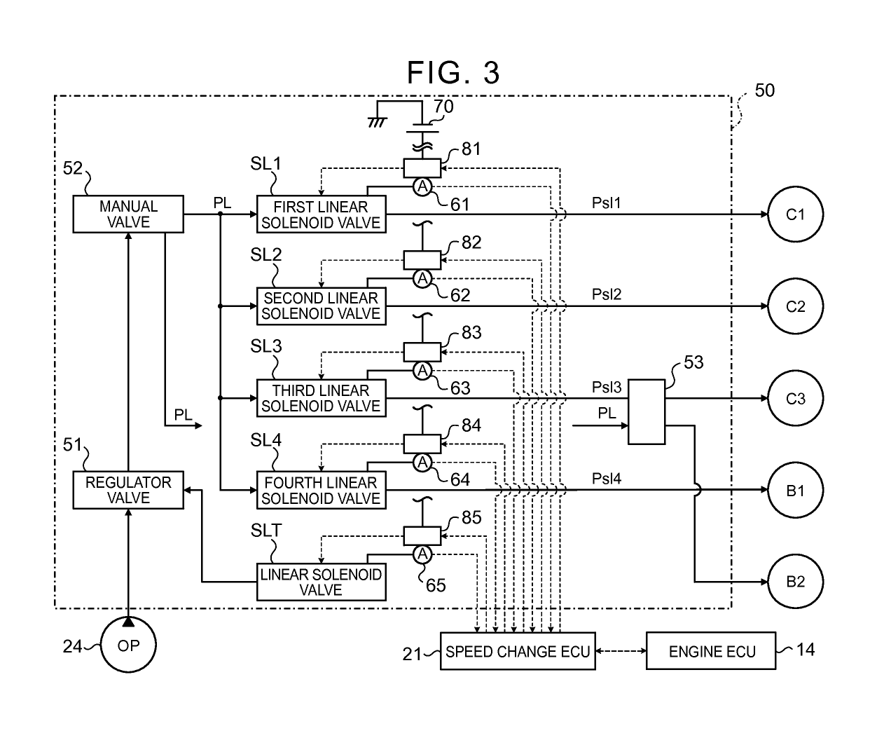

FIG. 1 is a diagram illustrating a schematic configuration of a power transfer device 20 for a vehicle including an automatic transmission 25 etc. FIG. 2 is an operation table illustrating the relationship between each shift speed of the automatic transmission 25 and the respective operating states of clutches and brakes. FIG. 3 is a system diagram illustrating a hydraulic control device 50 controlled by a speed change electronic control unit 21 that serves as a control device according to an embodiment of the present invention. As illustrated in FIG. 1, a power transfer device 20 includes a transmission case 22, a fluid transmission apparatus (torque converter) 23, an automatic transmission 25, a hydraulic control device 50 (see FIG. 3), and a speed change electronic control unit (hereinafter referred to as a “speed change ECU”) 21 (see FIG. 3) that controls the transmission case 22, the fluid transmission apparatus 23, the automatic transmission 25, and the hydraulic control device 50. The power transfer device 20 transfers power from an engine (internal combustion engine) that serves as a motor (not illustrated) to drive wheels (not illustrated).

The speed change ECU 21 is structured as a microcomputer including a CPU (not illustrated) as a main component, and includes a ROM that stores various programs, a RAM that temporarily stores data, input and output ports and a communication port (not illustrated), and so forth besides the CPU. The speed change ECU 21 receives inputs such as signals from various sensors (not illustrated) such as an accelerator operation amount Acc from an accelerator pedal position sensor, a shift range SR from a shift range sensor, a vehicle speed V from a vehicle speed sensor, an input rotational speed Nin input to the automatic transmission 25 from a rotational speed sensor, an oil temperature Toil of hydraulic oil in the hydraulic control device 50 (for example, in a valve body (not illustrated)) from an oil temperature sensor, and signals from current sensors 61 to 65 (see FIG. 3) that detect a current that flows through a solenoid of a linear solenoid valve SLT and first to fourth linear solenoid valves SL1 to SL4 to be discussed later included in the hydraulic control device 50, and signals from an engine electronic control unit (hereinafter referred to as an “engine ECU”) 14 (see FIG. 3) that controls the engine. The speed change ECU 21 controls the fluid transmission apparatus 23 and the automatic transmission 25, that is, the hydraulic control device 50, on the basis of such signals.

The fluid transmission apparatus 23 of the power transfer device 20 includes a pump impeller 23a on the input side connected to a crankshaft of the engine (not illustrated), a turbine runner 23b on the output side connected to an input shaft (input member) 26 of the automatic transmission 25, and a lock-up clutch 23c. An oil pump 24 is structured as a gear pump including a pump assembly composed of a pump body and a pump cover, and an externally toothed gear connected to the pump impeller 23a of the fluid transmission apparatus 23 via a hub. When the externally toothed gear is rotated by power from the engine (not illustrated), the oil pump 24 suctions hydraulic oil (ATF) reserved in an oil pan (not illustrated) to pump the hydraulic oil to the hydraulic control device 50.

The automatic transmission 25 is structured as a 6-speed transmission. The automatic transmission 25 includes a single-pinion type planetary gear mechanism 30, a Ravigneaux type planetary gear mechanism 35, and three clutches C1, C2, and C3, two brakes B1 and B2, and a one-way clutch F1 that change a power transfer path from the input side to the output side. The single-pinion type planetary gear mechanism 30 has a sun gear 31 which is an externally toothed gear held stationary with respect to the transmission case 22, a ring gear 32 which is an internally toothed gear disposed concentrically with the sun gear 31 and connected to the input shaft 26, a plurality of pinion gears 33 meshed with the sun gear 31 and meshed with the ring gear 32, and a carrier 34 that rotatably and revolvably holds the plurality of pinion gears 33.

The Ravigneaux type planetary gear mechanism 35 includes two sun gears 36a and 36b which are each an externally toothed gear, a ring gear 37 which is an internally toothed gear held stationary with respect to an output shaft (output member) 27 of the automatic transmission 25, a plurality of short pinion gears 38a meshed with the sun gear 36a, a plurality of long pinion gears 38b meshed with the sun gear 36b and the plurality of short pinion gears 38a and meshed with the ring gear 37, and a carrier 39 that rotatably and revolvably holds the plurality of short pinion gears 38a and the plurality of long pinion gears 38b, which are coupled to each other, and that is supported by the transmission case 22 via the one-way clutch F1. The output shaft 27 of the automatic transmission 25 is connected to the drive wheels (not illustrated) via a gear mechanism 28 and a differential mechanism 29.

The clutch C1 is a multi-plate friction-type hydraulic clutch (friction engagement element) that has a hydraulic servo structured from a piston, a plurality of friction plates and mating plates, an oil chamber supplied with hydraulic oil, and so forth, and that is capable of fastening and unfastening the carrier 34 of the single-pinion type planetary gear mechanism 30 and the sun gear 36a of the Ravigneaux type planetary gear mechanism 35 to and from each other. The clutch C2 is a multi-plate friction-type hydraulic clutch that has a hydraulic servo structured from a piston, a plurality of friction plates and mating plates, an oil chamber supplied with hydraulic oil, and so forth, and that is capable of fastening and unfastening the input shaft 26 and the carrier 39 of the Ravigneaux type planetary gear mechanism 35 to and from each other. The clutch C3 is a multi-plate friction-type hydraulic clutch that has a hydraulic servo structured from a piston, a plurality of friction plates and mating plates, an oil chamber supplied with hydraulic oil, and so forth, and that is capable of fastening and unfastening the carrier 34 of the single-pinion type planetary gear mechanism 30 and the sun gear 36b of the Ravigneaux type planetary gear mechanism 35 to and from each other.

The brake B1 is a hydraulic brake that is structured as a band brake or a multi-plate friction-type brake including a hydraulic servo, and that is capable of making the sun gear 36b of the Ravigneaux type planetary gear mechanism 35 stationary and movable with respect to the transmission case 22. The brake B2 is a hydraulic brake that is structured as a band brake or a multi-plate friction-type brake including a hydraulic servo, and that is capable of making the carrier 39 of the Ravigneaux type planetary gear mechanism 35 stationary and movable with respect to the transmission case 22.

The clutches C1 to C3 and the brakes B1 and B2 operate with hydraulic oil supplied thereto and discharged therefrom by the hydraulic control device 50. The automatic transmission 25 provides first to sixth forward speeds and one reverse speed when the clutches C1 to C3 and the brakes B1 and B2 are brought into the respective states illustrated in the operation table of FIG. 2.

As illustrated in FIG. 3, the hydraulic control device 50 is connected to the oil pump 24 discussed above which is driven by power from the engine (not illustrated) to suction hydraulic oil from the oil pan to discharge the hydraulic oil, and generates a hydraulic pressure required for the fluid transmission apparatus 23 and the automatic transmission 25 and supplies the hydraulic oil to portions to be lubricated such as various bearings. The hydraulic control device 50 includes, in addition to the valve body (not illustrated), a primary regulator valve 51 that regulates the pressure of hydraulic oil from the oil pump 24 to generate a line pressure PL, a manual valve 52 that switches the supply destination of the line pressure PL from the primary regulator valve 51 in accordance with the operating position of a shift lever (not illustrated), an application control valve 53, and the first linear solenoid valve SL1, the second linear solenoid valve SL2, the third linear solenoid valve SL3, and the fourth linear solenoid valve SL4 which serve as pressure regulation valves that regulate the line pressure PL as a source pressure supplied from the manual valve 52 (primary regulator valve 51) to generate a hydraulic pressure for the corresponding clutches etc., respectively, and so forth.

The primary regulator valve 51 generates a line pressure using a hydraulic pressure from the linear solenoid valve SLT as a signal pressure.

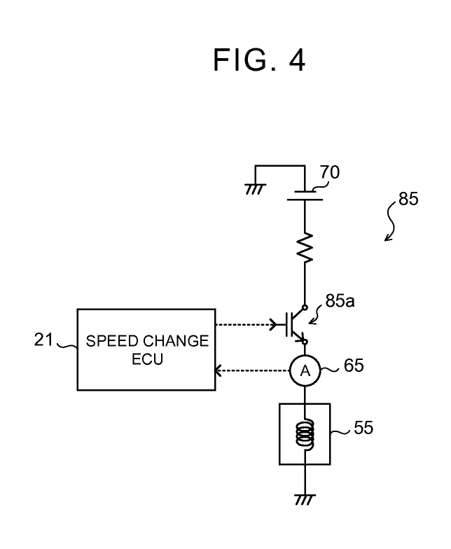

The linear solenoid valve SLT is structured as a normally-open linear solenoid valve that has a solenoid (see FIG. 4) 55 that opens and closes the valve, and that is capable of adjusting the output pressure in accordance with a current applied to the solenoid 55. The linear solenoid valve SLT is controlled by driving a drive circuit 85 illustrated in FIG. 4 through the speed change ECU 21. As illustrated in the drawing, the drive circuit 85 includes a battery 70 for vehicle accessories structured as a lead-acid battery with a rated output voltage of 12 V, and a transistor 85a that serves as a switching element and that is connected to the battery 70, for example. The drive circuit 85 is capable of adjusting a current that flows through the solenoid 55 by adjusting the proportion of the time for which the transistor 85a is turned on. In addition, the drive circuit 85 is provided with the current sensor 65 which detects a current that flows through the solenoid 55. The speed change ECU 21 controls the linear solenoid valve SLT by setting a hydraulic pressure command value that matches the accelerator operation amount Acc or the operation amount of a throttle valve (not illustrated), or torque input to the automatic transmission 25, and switching the transistor 85a of the drive circuit 85 such that a current that matches the hydraulic pressure command value is applied to the solenoid 55. This causes the linear solenoid valve SLT to regulate the pressure of hydraulic oil from the oil pump 24 side to output a hydraulic pressure corresponding to the hydraulic pressure command value.

The manual valve 52 has a spool that is axially slidable in conjunction with the shift lever (not illustrated), an input port to which the line pressure PL is supplied, a drive range output port that communicates with respective input ports of the first to fourth linear solenoid valves SL1 to SL4 via an oil passage, a reverse range output port, and so forth (none of which is illustrated). When the driver selects a forward travel shift range such as a drive range or a sport range, the spool of the manual valve 52 allows the input ports to communicate with only the drive range output port so that the line pressure PL is supplied to the first to fourth linear solenoid valves SL1 to SL4 as a drive range pressure. When the driver selects a reverse range, meanwhile, the spool of the manual valve 52 allows the input ports to communicate with only the reverse range output port. When the driver selects a parking range or a neutral range, further, the spool of the manual valve 52 blocks communication between the input ports and the drive range output port and the reverse range output port.

The application control valve 53 is a spool valve capable of selectively establishing a first state in which a hydraulic pressure from the third linear solenoid valve SL3 is supplied to the clutch C3, a second state in which the line pressure PL from the primary regulator valve 51 is supplied to the clutch C3 and the line pressure PL (reverse range pressure) from the reverse range output port of the manual valve 52 is supplied to the brake B2, a third state in which the line pressure PL (reverse range pressure) from the reverse range output port of the manual valve 52 is supplied to the clutch C3 and the brake B2, and a fourth state in which a hydraulic pressure from the third linear solenoid valve SL3 is supplied to the brake B2.

The first to fourth linear solenoid valves SL1 to SL4 are each structured as a normally-closed linear solenoid valve that has a solenoid that opens and closes the valve, and that is capable of adjusting the output pressure in accordance with a current applied to the solenoid. The first linear solenoid valve SL1 regulates the line pressure PL from the manual valve 52 in accordance with an applied current to generate a hydraulic pressure Psl1 for the clutch C1. The second linear solenoid valve SL2 regulates the line pressure PL from the manual valve 52 in accordance with an applied current to generate a hydraulic pressure Psl2 for the clutch C2. The third linear solenoid valve SL3 regulates the line pressure PL from the manual valve 52 in accordance with an applied current to generate a hydraulic pressure Psl3 for the clutch C3 or the brake B2. The fourth linear solenoid valve SL4 regulates the line pressure PL from the manual valve 52 in accordance with an applied current to generate a hydraulic pressure Psl4 for the brake B1. That is, hydraulic pressures for the clutches C1 to C3 and the brakes B1 and B2 which are friction engagement elements of the automatic transmission 25 are directly controlled (set) by the corresponding first, second, third, and fourth linear solenoid valve pressures SL1, SL2, SL3, and SL4.

The first to fourth linear solenoid valves SL1 to SL4 are controlled by the speed change ECU 21 which drives drive circuits 81 to 84 each structured in the same manner as the drive circuit 85 of FIG. 4. The drive circuits 81 to 84 are provided with the current sensors 61 to 64 which detect a current that flows through each solenoid, respectively. The speed change ECU 21 controls the first to fourth linear solenoid valves SL1 to SL4 so as to output a hydraulic pressure corresponding to the hydraulic pressure command value set as described below. That is, in order to establish a target shift speed corresponding to the accelerator operation amount Acc (or the operation amount of the throttle valve) and the vehicle speed V acquired from a speed change line diagram (not illustrated) determined in advance, the speed change ECU 21 sets a hydraulic pressure command value (engagement pressure command value) for one of the first to fourth linear solenoid valves SL1 to SL4 corresponding to a clutch or a brake (engagement element) to be engaged along with a change between shift speeds and a hydraulic pressure command value (disengagement pressure command value) for one of the first to fourth linear solenoid valves SL1 to SL4 corresponding to a clutch or a brake (disengagement element) to be disengaged along with the change between shift speeds. Further, the speed change ECU 21 sets a hydraulic pressure command value (holding pressure command value) for one or two of the first to fourth linear solenoid valves SL1 to SL4 corresponding to a clutch or a brake (engagement element) being engaged during the change between shift speeds or after completion of shifting.

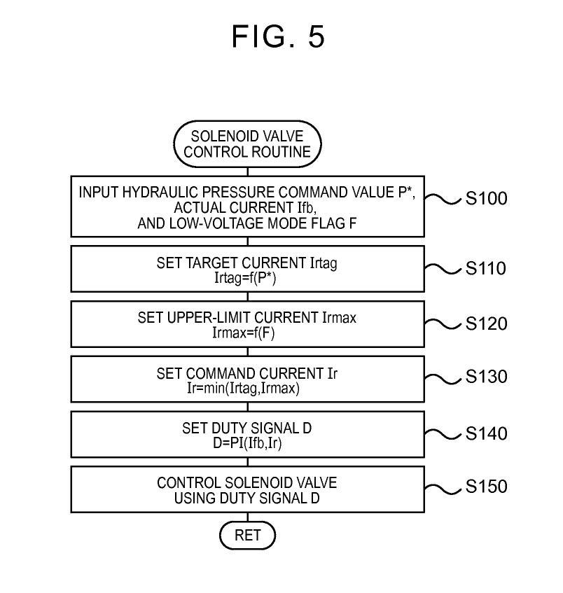

Next, operation performed in controlling the linear solenoid valve SLT and the first to fourth linear solenoid valves SL1 to SL4 included in the hydraulic control device 50 provided in the thus configured power transfer device 20, in particular operation performed in controlling the linear solenoid valve SLT, will be described as an example. FIG. 5 is a flowchart illustrating an example of a solenoid valve control routine for controlling the linear solenoid valve SLT executed by the speed change ECU 21. The routine is executed repeatedly at intervals of a predetermined time (for example, at intervals of several milliseconds) after an ignition switch of the vehicle is turned on.

When the solenoid valve control routine is executed, the CPU of the speed change ECU 21 first executes a process for inputting data that are necessary for control, such as a hydraulic pressure command value P* for the linear solenoid valve SLT, an actual current Ifb which is a current that flows through the solenoid 55 detected by the current sensor 65 of the drive circuit 85, and a low-voltage mode flag F which indicates whether or not the battery 70 which supplies electric power (applies a voltage) to the solenoid 55 is in a low-voltage state (step S100). Here, the input hydraulic pressure command value P* has been set in accordance with the accelerator operation amount Acc from the accelerator pedal position sensor (not illustrated) or the like. In addition, the low-voltage mode flag F is a flag that is set to a value of 0 when the mode of the battery 70 (hereinafter simply referred to as a “battery mode”) is a normal mode, and to a value of 1 when the battery mode is a low-voltage mode. The low-voltage mode flag F has been set by the engine ECU 14, and is input through communication.

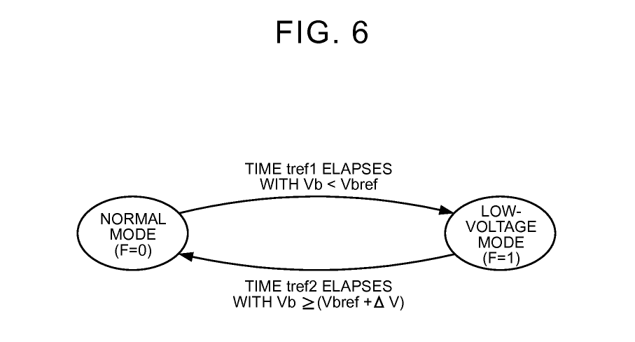

FIG. 6 illustrates an example of how the battery mode is switched by the engine ECU 14 in accordance with the state of the battery 70. As illustrated in the drawing, two modes, namely the normal mode and the low-voltage mode, are prepared in advance as the battery mode according to the embodiment. In the embodiment, during the normal mode (during normal times), the battery mode is switched from the normal mode (F=0) to the low-voltage mode (F=1) when a battery voltage Vb obtained from a voltage sensor (not illustrated) that detects a voltage across terminals of the battery 70 is less than a voltage threshold Vbref (for example, 10 V or 10.5 V which is several volts lower than the rated output voltage) determined in advance as the lower limit of the voltage range for use in the normal mode, that is, the lower limit of the voltage range allowed for normal use of the battery 70, and a time tref1 (for example, several tens of milliseconds) determined in advance for confirmation of such a state elapses.

Meanwhile, during the low-voltage mode (during low-voltage times), the battery mode is switched from the low-voltage mode (F=1) to the normal mode (F=0) when the battery voltage Vb of the battery 70 is equal to or more than a threshold (Vbref+ΔV) obtained by adding a voltage ΔV (for example, several hundreds of millivolts) for suppressing frequent mode switching to the voltage Vbref and a time tref2 (for example, several hundreds of milliseconds or about one second) determined in advance for confirmation of such a state elapses. The voltage ΔV and the time tref2 may be set on the basis of the amplitude and the period of vibration of the battery voltage Vb.

When data are input in step S100, a target current Irtag that is to flow through the solenoid 55 of the linear solenoid valve SLT is set on the basis of the input hydraulic pressure command value P* (step S110). In the embodiment, the setting is performed by providing the hydraulic pressure command value P* to a map prepared by determining in advance the relationship between the hydraulic pressure command value P* and the target current Irtag and stored in the ROM (not illustrated) to derive the target current Irtag. In the embodiment, the linear solenoid valve SLT is a normally-open type, and thus the target current Irtag for the linear solenoid valve SLT is set to be larger as the hydraulic pressure command value P* is smaller and the operation amount of the valve is smaller.

Subsequently, an upper-limit current Irmax that is determined in advance as the upper limit (upper-limit guard value, maximum value) of the target current Irtag for the linear solenoid valve SLT which is to be controlled in the routine, among the linear solenoid valve SLT and the first to fourth linear solenoid valves SL1 to SL4, is set on the basis of the input low-voltage mode flag F (step S120). The target current Ir is restricted (that is, the upper limit of the target current Ir is guarded) by the formula (1) using the set upper-limit current Irmax to set a command current Ir (step S130). Here, in the embodiment, the upper-limit current Irmax is set using an upper-limit current setting table prepared by determining in advance the relationship between the low-voltage mode flag F and the upper-limit current Irmax for each of the linear solenoid valve SLT and the first to fourth linear solenoid valves SL1 to SL4 and stored in the ROM (not illustrated).

Ir=min(Irtag,Irmax) (1)

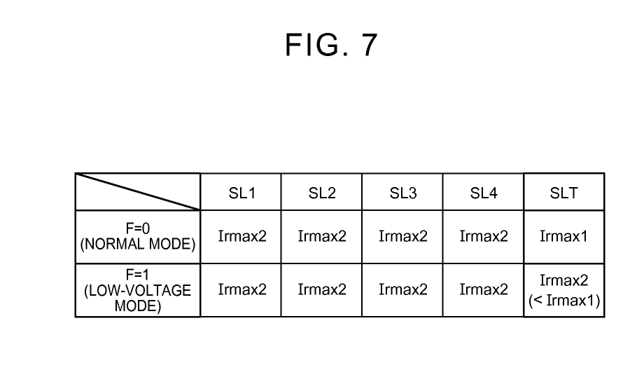

FIG. 7 illustrates an example of the upper-limit current setting table. In the upper-limit current setting table according to the embodiment, as illustrated in the drawing, it is determined which of a first upper-limit current Irmax1 and a second upper-limit current Irmax2 is used when the battery mode is the normal mode (F=0) and that the first upper-limit current Irmax2 is used when the battery mode is the low-voltage mode (F=1) for each of the linear solenoid valve SLT and the first to fourth linear solenoid valves SL1 to SL4. Specifically, for the linear solenoid valve SLT, the respective upper-limit currents Irmax for use in the normal mode and the low-voltage mode are set to different values, with the upper-limit current Irmax for use in the normal mode (F=0) set to the first upper-limit current Irmax1, and with the upper-limit current Irmax for use in the low-voltage mode (F=1) set to the second upper-limit current Irmax2 which is smaller than the first upper-limit current Irmax1. For each of the first to fourth linear solenoid valves SL1 to SL4, on the other hand, the respective upper-limit currents Irmax for use in the normal mode and the low-voltage mode are set to the same value, with the upper-limit current Irmax for use in the normal mode (F=0) set to the second upper-limit current Irmax2, and with the upper-limit current Irmax for use in the low-voltage mode (F=1) also set to the second upper-limit current Irmax2. The reason that the upper-limit current Irmax for the linear solenoid valve SLT is changed in accordance with the battery mode will be discussed later. In the embodiment, the first upper-limit current Irmax1 is determined in advance as a value of the command current Ir for fully closing the linear solenoid valve SLT, that is, bringing the hydraulic pressure output from the linear solenoid valve SLT to a value of 0. Meanwhile, the second upper-limit current Irmax2 is determined in advance as a value of the command current Ir that is smaller than the first upper-limit current Irmax1 by an amount (for example, several tens of milliamperes or about 100 mA) that does not hinder normal use of the linear solenoid valve SLT.

When the command current Ir for the solenoid 55 of the linear solenoid valve SLT is set in step S130, a duty signal D is set as a drive signal for the solenoid 55 (a control signal for the linear solenoid valve SLT) by the formula (2) using the actual current Ifb and the command current Ir (step S140). The transistor 85a of the drive circuit 85 is controlled on and off in accordance with the set duty signal D (step S150). The solenoid valve control routine is ended. The formula (2) is a relational formula for feedback control for causing the actual current Ifb to match the command current Ir. In the formula (2), the first term on the right side is a feedforward term obtained by converting the command current Ir into a reference duty that serves as a reference value for the proportion of the time for which the transistor 85a is turned on, “k1” in the second term on the right side is the gain of the proportional term, and “k2” in the third term on the right side is the gain of the integral term. Such control allows the linear solenoid valve SLT to output a hydraulic pressure corresponding to the hydraulic pressure command value P*.

D=f(Ir*)+k1·(Ir−Ifb)+k2·∫(Ir−Ifb)dt (2)

The control for the first to fourth linear solenoid valves SL1 to SL4 is performed in the same manner as the control for the linear solenoid valve SLT, and therefore will not be described in detail. In the embodiment, the first to fourth linear solenoid valves SL1 to SL4 are each a normally-closed type, and thus the target current Irtag (command current Ir) for the first to fourth linear solenoid valves SL1 to SL4 is set to be larger as the hydraulic pressure command value P* is larger and the operation amount of the valve is larger.

Here, the reason that the upper-limit current Irmax for the linear solenoid valve SLT is changed in accordance with the battery mode will be described. When the battery mode is the low-voltage mode (F=1), the actual current Ifb which flows through the solenoid 55 tends to be small because of a reduction in voltage of the battery 70, and therefore the deviation between the command current Ir and the actual current Ifb tends to be large. Thus, the proportional term and the integral term of the relational formula (2) for the feedback control discussed above may be excessively large, which may cause a control failure in the feedback control, or an abnormality (fault) in the control system including the solenoid 55 and the drive circuit 85 may be erroneously detected on the basis of the magnitude of the integral term to cause an adjustment failure in the line pressure PL. In the embodiment, in order to address such an issue, in controlling the linear solenoid valve SLT, the command current Ir is set within the range of the first upper-limit current Irmax1 during the normal mode (F=1) in which the voltage of the battery 70 is not reduced, and the command current Ir is set to be restricted within the range of the second upper-limit current Irmax2 which is smaller than the first upper-limit current Irmax1 during the low-voltage mode (F=1) in which the voltage of the battery 70 is reduced. Thus, it is possible to prevent the deviation between the command current Ir and the actual current Ifb for the solenoid 55 from becoming excessively large, and to perform current control for the solenoid 55 more adequately. That is, it is possible to suppress a control failure in the control system for current feedback control for the solenoid 55 and erroneous detection of an abnormality.

The reason that the upper-limit current Irmax for the linear solenoid valve SLT is changed in accordance with the battery mode will further be described. The linear solenoid valve SLT is a normally-open type as discussed above, and therefore outputs a maximum hydraulic pressure in the case where no electric power is supplied to the linear solenoid valve SLT. In addition, the primary regulator valve 51 which uses a hydraulic pressure from the linear solenoid valve SLT as a signal pressure to output the line pressure PL is structured to output the line pressure PL in proportion to the hydraulic pressure output from the linear solenoid valve SLT, and therefore the line pressure PL is also higher as the hydraulic pressure output from the linear solenoid valve SLT is higher. In addition, in the case where an abnormality (fault) in the linear solenoid valve SLT is detected because the deviation between the command current Ir and the actual current Ifb becomes larger than an allowable range, for example, or in the case where the voltage Vb of the battery 70 is lower than a predetermined value (for example, a value that is less than the voltage threshold Vbref discussed above), the speed change ECU 21 performs a fail-safe process in which the line pressure PL is set to be maximum in a range determined in advance to bring the command current Ir for the linear solenoid valve SLT to a value of 0 in order to engage necessary friction engagement elements such as clutches and brakes. Thus, if an abnormality (fault) in the linear solenoid SLT is erroneously detected because of a reduction in voltage of the battery 70, the line pressure PL may be brought to a maximum pressure to adversely affect efficiency (fuel economy). In the embodiment, in order to address such an issue, during the low-voltage mode (F=1), the command current Ir is set to be restricted within the range of the second upper-limit current Irmax2 which is smaller than the first upper-limit current Irmax1, which prevents a failure in the linear solenoid valve SLT from being erroneously detected and suppresses unnecessary performance of the fail-safe process so that the line pressure PL is adequately set during the low-voltage mode. As a result, degradation in efficiency (fuel economy) can be prevented.

In the embodiment, in addition, the upper-limit current Irmax for each of the linear solenoid valve SLT and the first to fourth linear solenoid valves SL1 to SL4 can be set on the basis of the upper-limit current setting table prepared by determining in advance the relationship of the upper-limit current Irmax during the normal mode (F=0) and the low-voltage mode (F=1) for each linear solenoid valve. That is, the upper-limit current Irmax for each linear solenoid valve is individually adjustable in accordance with the battery mode. Then, the upper-limit current Irmax for the linear solenoid valve SLT, among the linear solenoid valve SLT and the first to fourth linear solenoid valves SL1 to SL4, is changed from the first upper-limit current Irmax1 to the second upper-limit current Irmax2 in accordance with a reduction in voltage of the battery 70. By selecting the linear solenoid valve SLT as the target for which the upper-limit current Irmax is to be changed in accordance with the type (whether a normally-open type or a normally-closed type, for example) and the usage (usage of the output hydraulic pressure) of the linear solenoid valve in this way, it is possible to perform current control for the solenoid 55 more adequately, and to adjust the output hydraulic pressure for line pressure generation more adequately.

According to control performed by the speed change ECU 21 for the linear solenoid valve SLT included in the hydraulic control device 50 according to the embodiment described above, the command current Ir for use for current feedback control for the solenoid 55 is set within the range of the upper-limit current Irmax, and the upper-limit current Irmax is changed from the first upper-limit current Irmax1 to the second upper-limit current Irmax2 which is smaller than the first upper-limit current Irmax1 in accordance with a reduction in voltage of the battery 70 which supplies electric power to the solenoid 55. That is, the command current Ir is set within the range of the first upper-limit current Irmax1 when the voltage of the battery 70 is not reduced, and the command current Ir is set within the range of the second upper-limit current Irmax2 which is smaller than the first upper-limit current Irmax1 when the voltage of the battery 70 is reduced. Consequently, the command current Ir is restricted within the range of the smaller upper-limit current Irmax in accordance with a reduction in voltage of the battery 70, which prevents the deviation between the command current Ir and the actual current Ifb for the solenoid 55 from becoming excessively large. As a result, current control for the solenoid 55 can be performed more adequately.

In the control performed by the speed change ECU 21 according to the embodiment, the upper-limit current Irmax for only the linear solenoid valve SLT, among the linear solenoid valve SLT and the first to fourth linear solenoid valves SL1 to SL4, is changed from the first upper-limit current Irmax1 to the second upper-limit current Irmax2 (Irmax2<Irmax1) in accordance with a reduction in voltage of the battery 70. However, an upper-limit value that is smaller than the upper-limit value for use in the normal mode may be set during the low-voltage mode as the upper-limit current Irmax for linear solenoid valves other than the linear solenoid valve SLT.

In the control performed by the speed change ECU 21 according to the embodiment, the upper-limit current Irmax for the command current Ir is set on the basis of the upper-limit current setting table prepared by determining in advance the relationship of the upper-limit current Irmax during the normal mode and the low-voltage mode for each of the linear solenoid valve SLT and the first to fourth linear solenoid valves SL1 to SL4. However, such an upper-limit current setting table may not be used. For example, the first upper-limit current Irmax1 for use in the normal mode and the second upper-limit current Irmax2 for use in the low-voltage mode may be set in advance as the upper-limit current Irmax for the linear solenoid valve SLT, and the battery mode may be determined to select one of the upper limit currents.

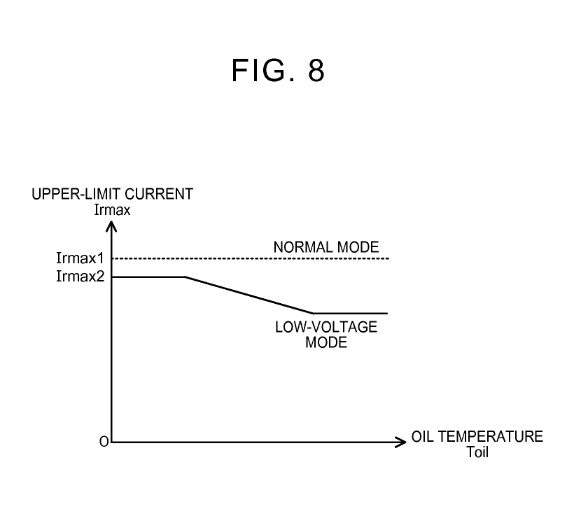

In the control performed by the speed change ECU 21 according to the embodiment, the upper-limit current Irmax for the linear solenoid valve SLT is set to the first upper-limit current Irmax1 or the second upper-limit current Irmax2 in accordance with the battery mode (low-voltage mode flag F). However, the upper-limit current Irmax for the linear solenoid valve SLT may be set on the basis of the oil temperature Toil of hydraulic oil in the hydraulic control device 50 obtained from the oil temperature sensor (not illustrated) as long as a value that is smaller than that for use in the normal mode is used during the low-voltage mode as the upper-limit current Irmax for the linear solenoid valve SLT. For example, the first upper-limit current Irmax1 which has a constant value may be set as the upper-limit current Irmax for the linear solenoid valve SLT when the battery mode is the normal mode, and the upper-limit current Irmax which has a tendency to become smaller from the second upper-limit current Irmax2 which is smaller than the first upper-limit current Irmax1 as the oil temperature Toil becomes higher may be set using an upper-limit current setting map illustrated in FIG. 8 when the battery mode is the low-voltage mode. In the example of FIG. 8, further, the upper-limit current Irmax which has a tendency to become smaller from the first upper-limit current Irmax1 within the range of values that are larger than the upper-limit current Irmax for use in the low-voltage mode as the oil temperature Toil becomes higher may be set when the battery mode is the normal mode. Such use of the oil temperature Toil of hydraulic oil is based on the fact that the deviation between the command current Ir and the actual current Ifb for the solenoid 55 tends to become excessively large when the oil temperature Toil of hydraulic oil in the hydraulic control device 50 becomes higher, which increases the resistance value of the solenoid 55 and therefore reduces the actual current Ifb which flows through the solenoid 55. In addition, the upper-limit current Irmax is set on the basis of the oil temperature Toil, and therefore the upper-limit current Irmax can be prevented from becoming unnecessarily small.

In the control performed by the speed change ECU 21 according to the embodiment, the solenoid 55 is driven by setting the duty signal D through feedback control such that the actual current Ifb matches the command current Ir. However, the solenoid 55 may be driven by setting a target voltage through feedback control such that the actual current Ifb matches the command current Ir, generating a PWM signal on the basis of the set target voltage, and outputting the generated PWM signal to the transistor 85a of the drive circuit 85.

In the embodiment, the present invention is applied to control for the linear solenoid valve SLT included in the hydraulic control device 50 provided in the power transfer device 20 for a vehicle. However, the present invention may also be applied to control for a solenoid valve included in a hydraulic control device provided in movable bodies other than vehicles, immovable equipment, or the like. In addition, the present invention may be embodied as a control method for a solenoid valve.

Here, the correspondence between the main elements of the embodiment and the main elements of the invention described in the “SUMMARY OF THE INVENTION” section will be described. In the embodiment, the hydraulic control device 50 corresponds to the “hydraulic control device”. The linear solenoid valve SLT corresponds to the “solenoid valve”. The speed change ECU 21 which executes the processes in steps S110 to S130 of the solenoid valve control routine of FIG. 5 in which the target current Irtag is set on the basis of the hydraulic pressure command value P*, the upper-limit current Irmax is set on the basis of the low-voltage mode flag F, and the target current Irtag is restricted using the upper-limit current Irmax to set the command current Ir corresponds to the “command current setting means”. The correspondence between the main elements of the embodiment and the main elements of the invention described in the “SUMMARY OF THE INVENTION” section does not limit the elements of the invention described in the “SUMMARY OF THE INVENTION” section, because such correspondence is an example given for the purpose of specifically describing the invention described in the “SUMMARY OF THE INVENTION” section. That is, the invention described in the “SUMMARY OF THE INVENTION” section should be construed on the basis of the description in that section, and the embodiment is merely a specific example of the invention described in the “SUMMARY OF THE INVENTION” section.

While a mode for carrying out the present invention has been described above by way of an embodiment, it is a matter of course that the present invention is not limited to the embodiment in any way, and that the present invention may be implemented in various forms without departing from the scope and sprit of the present invention.

### INDUSTRIAL APPLICABILITY

The present invention is applicable to the solenoid valve control device manufacturing industry and so forth.

1. A control device for a solenoid valve that controls a solenoid valve included in a hydraulic control device using a control signal set through feedback control such that an actual current that flows through a solenoid of the solenoid valve matches a command current, comprising:
command current setting means for setting the command current within a range of an upper-limit current, wherein
the command current setting means is means for changing the upper-limit current from a first upper-limit value to a second upper-limit value that is smaller than the first upper-limit value in accordance with a reduction in voltage of a battery that supplies electric power to the solenoid.

2. The control device for a solenoid valve according to claim 1, wherein
the hydraulic control device includes a plurality of such solenoid valves, and
the command current setting means is means for changing the upper-limit current for at least one of the plurality of solenoid valves from the first upper-limit value to the second upper-limit value in accordance with a reduction in voltage of the battery.

3. The control device for a solenoid valve according to claim 1, wherein
the command current setting means is means for changing the upper-limit current from the first upper-limit value to the second upper-limit value when the voltage of the battery is less than a threshold determined in advance as a lower limit of a voltage range allowed for normal use.

4. The control device for a solenoid valve according to claim 1, wherein
the second upper-limit value is a value set to have a tendency to become smaller as a temperature of hydraulic oil in the hydraulic control device becomes higher.

5. The control device for a solenoid valve according to claim 1, wherein
the hydraulic control device is a device that controls a hydraulic pressure for an engagement element included in an automatic transmission mounted on a vehicle, and includes a regulator valve that generates a line pressure that serves as a source pressure for engaging the engagement element in accordance with a hydraulic pressure from the solenoid valve which outputs a hydraulic pressure matching a throttle operation amount or torque input to the automatic transmission, and
the solenoid valve is controlled such that the line pressure is brought to a maximum pressure determined in advance at least in the case where an abnormality in the solenoid valve is detected.

6. A control method for a solenoid valve in which a solenoid valve included in a hydraulic control device is controlled using a control signal set through feedback control such that an actual current that flows through a solenoid of the solenoid valve matches a command current, characterized by comprising the step of:
setting the command current within a range of an upper-limit current, wherein
the upper-limit current is changed from a first upper-limit value to a second upper-limit value that is smaller than the first upper-limit value in accordance with a reduction in voltage of a battery that supplies electric power to the solenoid.
